(19) United States
(12) Patent Application Publication
(10) Pub. No.: US 2017/0031109 A1
(43) Pub. Date: Feb. 2, 2017

(54) OPTICAL COMMUNICATIONS MODULE EQUIPPED WITH A MOVING-PIN LATCHING/DELATCHING SYSTEM THAT INCLUDES AN ELONGATED DELATCHING PULL TAB

(71) Applicant: Avago Technologies General IP (Singapore) Pte. Ltd, Singapore (SG)

(72) Inventors: David J.K. Meadowcroft, San Jose, CA (US); Paul Yu, Sunnyvale, CA (US)

(21) Appl. No.: 14/818,755

(22) Filed: Aug. 5, 2015

Related U.S. Application Data
(60) Provisional application No. 62/198,671, filed on Jul. 29, 2015.

(51) Int. Cl. G02B 6/38; G02B 6/42

(52) U.S. Cl. CPC G02B 6/3893; G02B 6/4292; G02B 6/4277; G02B 6/387

(57) ABSTRACT

An optical communications module is provided with a moving pin latching/delatching system that includes an elongated pull tab that is easily accessible and a latch base having a proximal end that is mechanically coupled to a distal end of the pull tab. The latch base has a latch locking pin disposed on a distal end thereof for engaging a latch opening of a cage when the module is mated with the cage and the latch base is in the latched position. When a pull force of sufficient magnitude is exerted on the pull tab in a direction away from the cage parallel to a longitudinal axis of the pull tab, the latch base is moved from a latched position to a delatched position, which causes the pin to move from an extended position to a retracted position in which the pin is disengaged from the opening of the cage.

### CROSS-REFERENCE TO RELATED APPLICATIONS

This application claims priority to and the benefit of the filing date of provisional application Ser. No. 62/198,671 filed on Jul. 29, 2015, entitled “AN OPTICAL COMMUNICATIONS MODULE EQUIPPED WITH A MOVING-PIN LATCHING/DELATCHING SYSTEM THAT INCLUDES AN ELONGATED DELATCHING PULL TAB,” and which is incorporated by reference herein in its entirety.

### TECHNICAL FIELD OF THE INVENTION

The invention relates to optical communications modules. More particularly, the invention relates to an optical communications module equipped with a latching/delatching system that includes an elongated delatching pull tab that is used for actuating a moving pin of the latching/delatching system.

### BACKGROUND OF THE INVENTION

Optical communications modules include optical receiver modules, optical transmitter modules and optical transceiver modules. In order to meet ever-increasing demands for higher information bandwidth, state-of-the-art digital communication switches, servers, and routers often use multiple rows of optical communications modules arranged in very close proximity to one another to increase module density. To be a commercially fungible product, the optical communications modules generally need to have basic dimensions and functionality that conform to an industry standard Multi-Source Agreement (MSA). Of course, many optical communications module designs that comply with and add value beyond the basic functionally set forth in the MSA are possible.

One known optical transceiver module design that complies with such an MSA is the Small Form-Factor Pluggable (SFP) optical communications module. SFP optical communications modules are available in a variety of designs. Enhanced versions of SFP optical communications modules that support data rates of up to 16 Gigabits per second (Gpbs) are referred to as “SFP+” optical communications modules. SFP and SFP+ optical communications modules are referred to herein collectively as “SFP-type” optical communications modules. SFP-type optical communications modules are designed to mate with an opening formed in a cage. SFP-type module housings have one or more receptacles configured to mate with one or more respective optical connectors that terminate ends of respective optical fiber cables. The most common type of optical connector used with SFP-type optical communications modules is called the LC optical connector.

SFP-type optical communications modules are configured to be inserted into an opening of a cage. When an SFP-type of optical communications module is in a stored position inside of a cage, a latching/delatching system on the module is engaged with a latching/delatching system of the cage. The latching/delatching system of the module typically includes a latch locking pin and the latching/delatching system of the cage typically includes a tongue having an opening in it that engages the pin. In fixed-pin (FP) latching/delatching systems, the pin is stationary relative to the module housing and delatching of the pin from the opening is performed by moving the tongue of the cage to cause it to disengage from the pin. The module may then be extracted from the cage. In moving-pin (MP) latching/delatching systems, the pin is movable relative to the module housing and the tongue is stationary relative to the cage. Delatching of the pin from the opening is performed by moving the pin to cause it to disengage from the opening.

MP designs are often preferred over FP designs because moving features of the module rather than features of the cage reduces dependency on the cage design and provides the potential for greater reliability across a larger variety of cage designs. Furthermore, because the cage tongue is deflected less in MP designs and thus undergoes less stress/strain, it is less likely to become fatigued or fail over time. Fatigue of the cage tongue can lead to latching problems that can result on the module inadvertently sliding out of the cage.

There are four primary goals of an MP latching/delatching system: (1) when the MP latching/delatching system is placed in the delatched position, the delatching mechanism of the system should disengage the pin from the tongue opening to allow the module to be extracted from the cage; (2) when the delatching mechanism is actuated from the delatched position to the latched position, the delatching mechanism should return to the latched position; (3) the MP latching/delatching system should not easily separate from the module housing during normal use of the module; and (4) the pin should not accidentally disengage the tongue opening when the MP latching/delatching system is in the latched position.

Known MP latching/delatching systems exist that include a latch base on which the latch locking pin is located and a bail that is operable by a user to actuate the system from the latched state to the delatched state, and vice versa. For example, U.S. Pat. Nos. 7,537,476 and 8,678,848, which are assigned to the assignee of the present application and which are incorporated by reference herein in their entireties, disclose MP latching/delatching systems having a latch base on which the latch locking pin is located and a bail that is operable by a user to actuate the system from the latched state to the delatched state, and vice versa.

FIG. 1 illustrates a standard configuration for a system 1 including an optical transceiver module 10 having a conventional FP delatch mechanism and a cage 12. Optical transceiver module 10 contains a transceiver that converts optical data signals received via an optical fiber (not shown) into electrical signals for an electrical switch (not shown) and converts electrical data signals from the switch into optical data signals for transmission. Cage 12 would typically be part of the switch and may be mounted in closely spaced rows above and below a printed circuit board.

When plugging module 10 into a switch, an operator slides module 10 into cage 12 until a post 14 on module 10 engages and lifts a latch tab 22 on cage 12. Module 10 then continues sliding into cage 12 until post 14 is even with a hole 24 in latch tab 22 at which point latch tab 22 springs down to latch module 10 in place with post 14 residing in hole 24. Post 14 is shaped such that an outward force on module 10 does not easily remove module 10 from cage 12. Module 10 has a delatch mechanism 30, which resides in a channel extending away from post 14. In a latched position, delatch mechanism 30 is outside cage 12, and post 14 is in hole 24. To remove module 10, delatch mechanism 30 is slid toward cage 12 until wedges 32 on delatch mechanism 30 slide under and lift latch tab 22 to a level above post 14. Module 10 can then be slid out and removed from cage 12.

Operation of delatch mechanism 30 can be awkward since removal of module 10 requires pushing in on delatch mechanism 30 while pulling out module 10. Additionally, when module 10 is in an array of modules in an optical switch, modules above module 10 will often block easy access to delatch mechanism 30, making removal of module 10 more difficult. Surrounding modules also make each module more difficult to grip.

Other FP module delatch mechanisms have been developed in attempts to simplify the removal procedure. One such module has a flexible strip that is attached to the module and resides under the latch tab in the latched position. To delatch the module, an operator pulls up and out on the flexible strip, which causes the flexible strip to lift the latch tab off of the post. Releasing the latch tab and removing the module in this manner requires significant upward force. For many operators, the operation of this delatch mechanism is not intuitive because pulling directly out without also pulling up on the flexible strip will not release the module. Additionally, in a high-density configuration, surrounding modules can make the flexible strip difficult to grip.

FIGS. 2A and 2B illustrate cutaway bottom perspective views of a known optical transceiver module 110 having an FP delatch mechanism 130 that does not require excessive force to extract from a cage 120 and that is easily accessible in high density module arrangements. The module 110 and the delatch mechanism 130 are disclosed in U.S. Pat. No. 6,746,158, which is assigned to the assignee of the present application and is incorporated by reference herein in its entirety.

In FIG. 2A, the delatch mechanism 130 is in a latched configuration. In FIG. 2B, the delatch mechanism 130 is in a delatched configuration. Half of cage 120 is cut away in FIGS. 2A and 2B to better show module 110 and the delatch mechanism 130. Cage 120 includes a latch tab 122 (half of which is shown in FIG. 2A) including a hole 124 that can accommodate a post 114. Although FIG. 2A illustrates cage 120 as being isolated, cage 120 would typically be one of several substantially identical cages arranged in a dense array of cages. The delatch mechanism 130 includes an integrated structure 140 and a bail 150. Integrated structure 140 includes features such as ridges 142 and 144, spring arms 146, and wedges 148. Bail 150 is friction fit through a hole in integrated structure 140 and can be flipped down as shown in FIG. 2A to keep the bail 150 out of the way, or flipped up as shown in FIG. 2B to extend out and facilitate pulling on delatch mechanism 130 during removal of module 110. Ridges 142 and 144 also provide grip points for pulling delatch mechanism 130 when bail 150 is down or is otherwise inconvenient for gripping. An LC fiber connector (not shown) can attach to module 110 through the center of bail 150.

Spring arms 146 have ends in notches 116 in module 110. The cut away view of FIG. 2A shows only one of notches 116, the other notch being omitted to better illustrate integrated structure 140. Spring arms 146 flex in response to a pulling force on delatch mechanism 130 and permit a limited range of motion for delatch mechanism 130 relative to module 110. In the latched configuration shown in FIG. 2A, spring arms 146 can be uncompressed or have some spring loading, and wedges 148 reside in pockets 112 in module 110. Above wedges 148 is latch tab 122, half of which is illustrated in FIG. 2A. Through latch tab 122 is hole 124, in which post 114 resides when module 110 is latched in cage 120.

To remove the module 110 from the cage 120, an operator pulls out on delatch mechanism 130 via bail 150 or ridges 142 and/or 144. Initial pulling bends/flexes spring arms 146 and slides wedges 148 out of their respective pockets 112. As wedges 148 rise out of pockets 112, wedges 148 push up on latch tab 122. In FIG. 2B, the spring arms 146 have reached a limit of their compression and wedges 148 have lifted latch tab 122 above post 114. The spring arms 146 are at angles such that pulling on integrated structure 140 flexes spring arms 146 about their respective bases and extends the ends of spring arms 146 further into notches 116 in module 110. Accordingly, pulling more firmly engages spring arms 146 in notches 116. In the illustrated configuration of FIG. 2B, spring arms 146 contact fixed portions 147 of delatch mechanism 130 and cannot flex further. The pulling force thus acts on module 110 to slide module 110 out of cage 120.

FIG. 3 illustrates a top perspective view of a known Quad Small Form-Factor Pluggable (QSFP) optical transceiver module 160 currently used in the optical communications industry. An optical fiber cable 163 is attached to the module 160 and includes a plurality of transmit optical fibers (not shown for purposes of clarity) and a plurality of receive optical fibers (not shown for purposes of clarity). The module 160 has a housing 165 that includes a first housing portion 165a and a second housing portion 165b, which are connected together by fastening elements. A delatch device 166 allows the module housing 165 to be delatched from a cage (not shown) to enable the module housing 165 to be removed from the cage. A flexible plastic pull tab 167 is connected on its proximal end 167a to the delatch device 166. When a user pulls on the distal end 167b of the pull tab 167 in the direction indicated by arrow 168, slider portions 166a and 166b of the delatch device 166 move to a limited extent in the direction indicated by arrow 168 (only slider portion 166a can be seen in FIG. 3). This movement of the slider portions 166a and 166b causes outwardly curved ramps 166a′ and 166b′ of the slider portions 166a and 166b, respectively, to press outwardly against respective catch features on the cage (not shown) to allow the housing 165 to be retracted from the cage.

Another known pull tab delatching mechanism is disclosed in U.S. Pat. No. 8,506,172, which is assigned to the assignee of the present application. Exerting a force on the pull tab of the delatching mechanism in a direction away from the cage opening causes slider portions of the delatch mechanism that are disposed on opposite sides of the module housing to move in the same direction. This movement of the slider portions causes outwardly curved ramps of the slider portions to press outwardly against respective catch features on the cage to allow the module to be extracted from the cage.

With reference again to FIG. 1, because the module 1 does not have a bail or a pull tab, removing it from the cage 12 when arranged in a densely-packed array of cages can be very challenging. With reference to FIGS. 2A and 2B, although the delatch mechanism 130 works well with regard to delatching and removing the module 110 from the cage 120, the bail 150 is fairly short, which can make the task of removing the module 110 from the cage 120 difficult in situations where many such modules are positioned adjacent one another in a densely-packed array. In addition, the module 110 cannot be removed from the cage 120 without first unplugging the optical fiber cables (not shown) from the cage 120 to enable the bail 150 to be moved to the delatch position. This makes it more difficult to use the module 110 in hot-pluggable environments. Another problem associated with some optical transceiver modules that use bail-type delatching configurations is that the bail is often coupled to the module housing by pins or screws that can damage the housing, resulting in lower yield. With respect to FIG. 3, the pins 171 that are used to attach the flexible plastic pull tab 167 to the module housing 165 sometimes damage the housing 165, resulting in lower yield.

While the pull tab delatching devices described above work well for their intended purposes, they require placing stress/strain on the catch features of the cage, which may lead to the catch features becoming fatigued over time. Fatigue of the catch features can lead to latching problems, which can result on the module inadvertently sliding out of the cage.

A need exists for a MP latching/delatching system that has a configuration that enables a user to easily latch and delatch an optical communications module to and from a cage without having to first unplug the optical fiber cable connected to the module and without having to exert stress/strain on elements of the cage that may lead to fatigue of those elements.

### BRIEF DESCRIPTION OF THE DRAWINGS

FIG. 1 illustrates a standard configuration for a system including an optical transceiver module having a conventional FP delatch mechanism and a cage.

FIGS. 2A and 2B illustrate cutaway bottom perspective views of a known optical transceiver module having an FP delatch mechanism that does not require excessive force to extract from a cage and that is easily accessible in high density module arrangements.

FIG. 3 illustrates a top perspective view of a known QSFP optical transceiver module currently used in the optical communications industry.

FIG. 4 illustrates a bottom perspective view of an SFP-type optical communications module equipped with the MP latching/delatching system in accordance with an illustrative embodiment.

FIG. 5 illustrates an enlarged bottom perspective of the portion of the optical communications module and MP latching/delatching system shown in the dashed circle 241 in FIG. 4.

FIG. 6 illustrates an enlarged side perspective of the portion of the optical communications module and MP latching/delatching system shown in the dashed circle 241 in FIG. 4.

FIGS. 7A and 7B illustrate top and bottom perspective views, respectively, of the MP latching/delatching system shown in FIGS. 4-6.

FIG. 7C illustrates a side elevation view of the MP latching/delatching system shown in FIGS. 4-6.

FIG. 8 illustrates an enlarged bottom perspective view of the distal end of the pull tab shown in FIGS. 7A-7C with the latch base of the MP latching/delatching system removed.

FIG. 9 illustrates a bottom perspective view of the latch base of the MP latching/delatching system shown in FIGS. 7A-7C.

FIG. 10 illustrates a bottom perspective view of a portion of the optical communications module and MP latching/delatching system shown in FIGS. 5 and 6, but with the EMI collar and the pull tab removed.

FIG. 11 illustrates a top perspective view of a portion of the optical communications module and the MP latching/delatching system shown in FIG. 4.

FIGS. 12A and 12B illustrate side plan and cross-sectional views, respectively, of the optical communications module shown in FIGS. 4-6 with the latch locking pin in the latched position.

FIGS. 13A and 13B illustrate side plan and cross-sectional views, respectively, of the optical communications module shown in FIGS. 4-6 with the latch locking pin in the delatched position.

FIG. 14 illustrates a side cross-sectional view of a portion of the optical communications module shown in FIGS. 4-6 that shows the interaction between the latch locking pin, the lower housing portion and one of the push fingers of the MP latching/delatching system shown in FIGS. 7A-8 as the pull tab is being pulled to move the latch locking pin from the latched position shown in FIGS. 12A and 12B to the delatched position shown in FIGS. 13A and 13B.

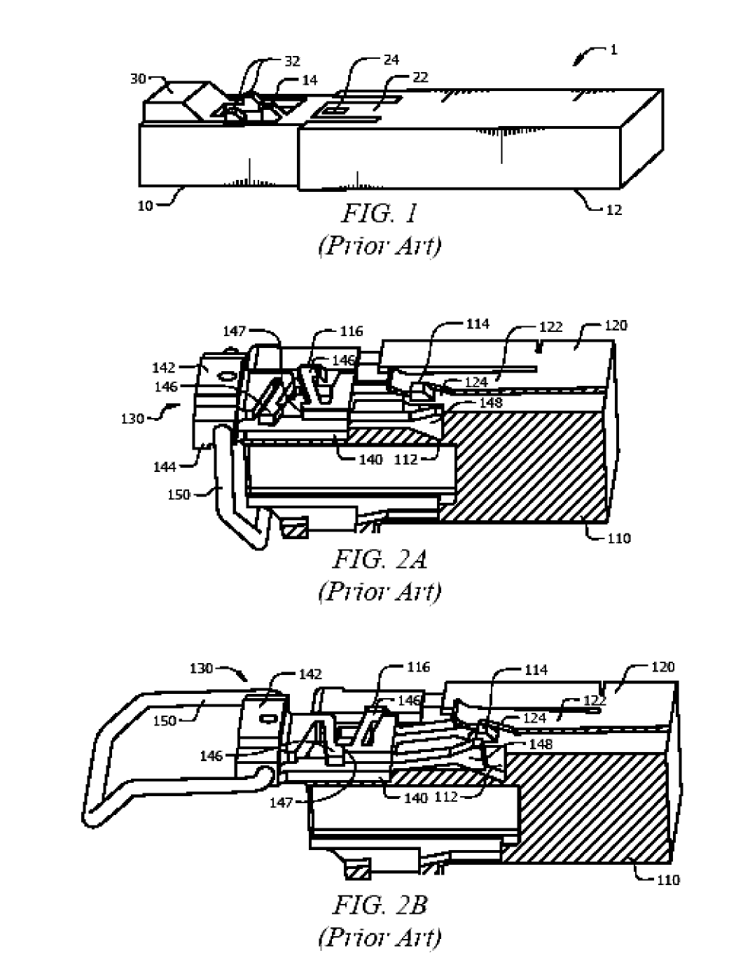

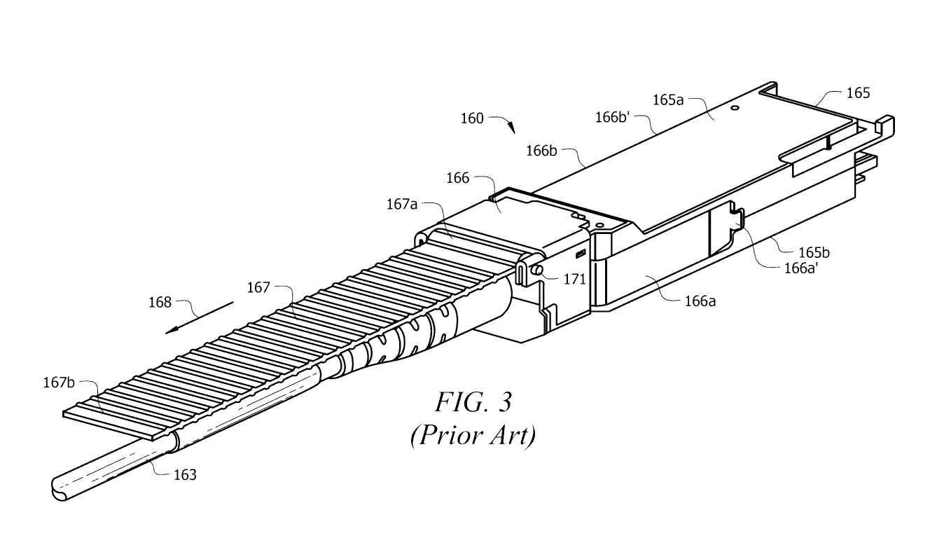

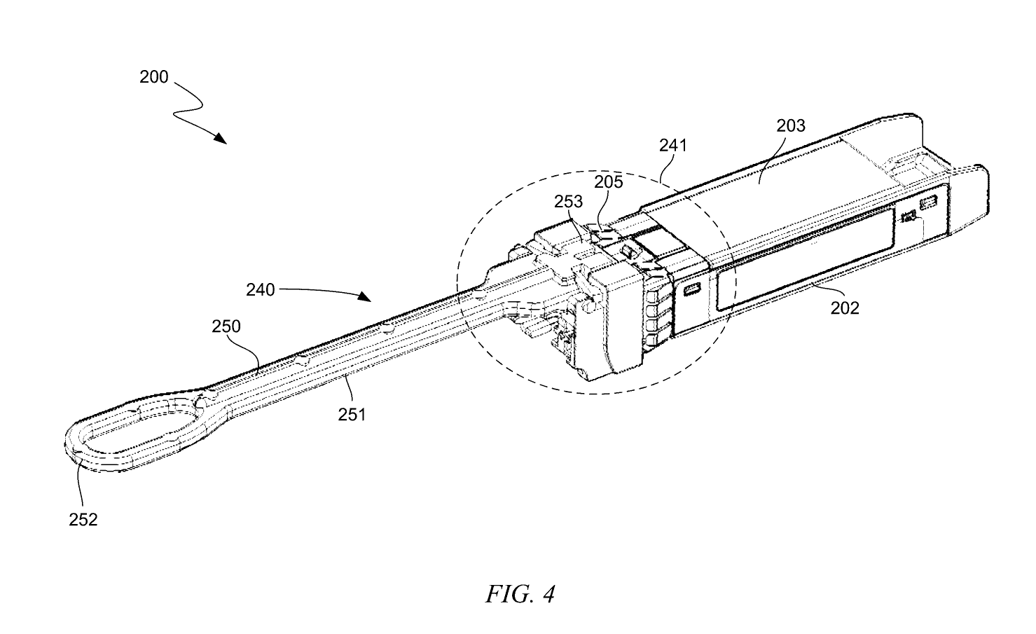

### DETAILED DESCRIPTION OF AN ILLUSTRATIVE EMBODIMENT

In accordance with the illustrative embodiments described herein, an optical communications module is provided with an MP latching/delatching system that includes an elongated pull tab that is easily accessible and a latch base having a proximal end that is mechanically coupled to a distal end of the pull tab. The latch base has a latch locking pin disposed on a distal end thereof for engaging a latch opening of a cage when the module is mated with the cage and the MP latching/delatching system is in the latched position. The MP latching/delatching system is placed in a delatched position by exerting a pull, or extraction, force on the pull tab in a direction away from the cage parallel to a longitudinal axis of the pull tab. When the pull force exerted in this direction is of sufficient magnitude, the latch base is moved from a latched position to a delatched position. Movement of the latch base from the latched position to the delatched position causes the pin to move from an extended position to a retracted position in which the pin is disengaged from the opening of the cage to allow the module to be extracted from the cage. Once the latch locking pin has been placed in the retracted position, the module can be extracted from the cage by continued exertion of the pull force on the pull tab.

One of the benefits of the pull tab is that it can be used to extract the module from the cage without having to first unplug the optical connectors of the optical fiber cables that are connected to the receptacles of the module. This not only saves time, but also reduces the likelihood that the optical fibers and/or the module will become dirty or contaminated while the optical fiber cables are disconnected from the receptacles. Another advantage is that, because actuation by the pull tab does not result in stress/strain being placed on elements of the cage, fatigue of cage elements will not occur. Other features and advantages of the MP latching/delatching system will become apparent from the following description of the figures, in which like reference numerals represent like elements, components or features. It should be noted that features, components or elements shown in the figures are not necessarily drawn to scale, emphasis instead being placed on demonstrating the principles and concepts of the invention.

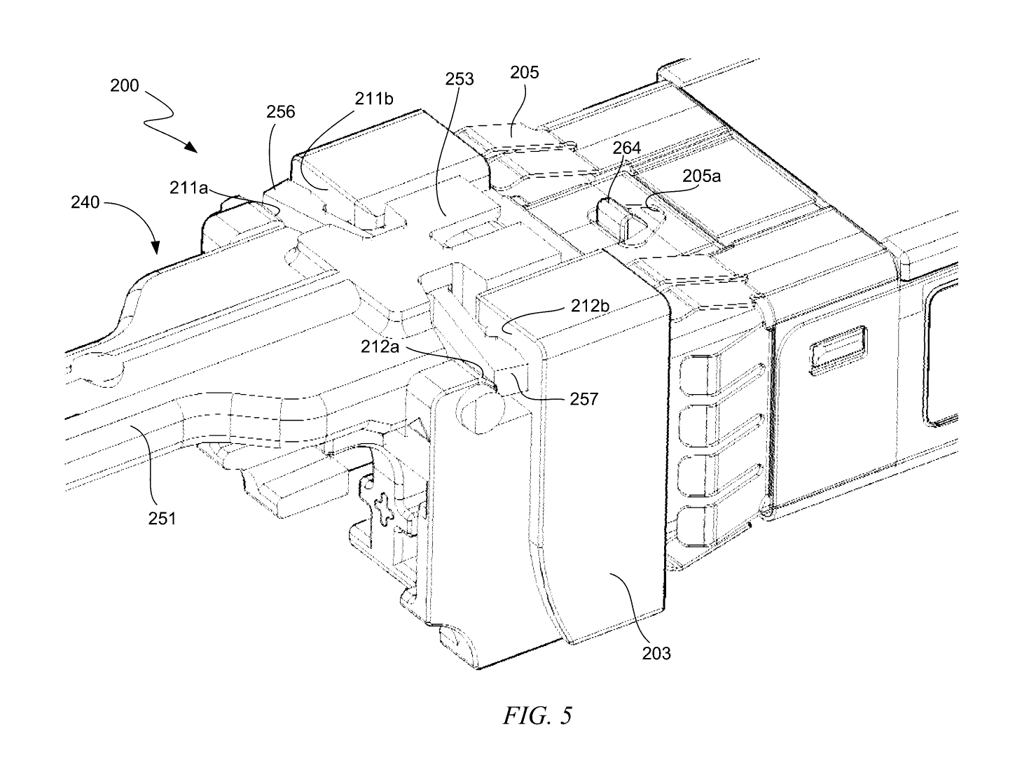

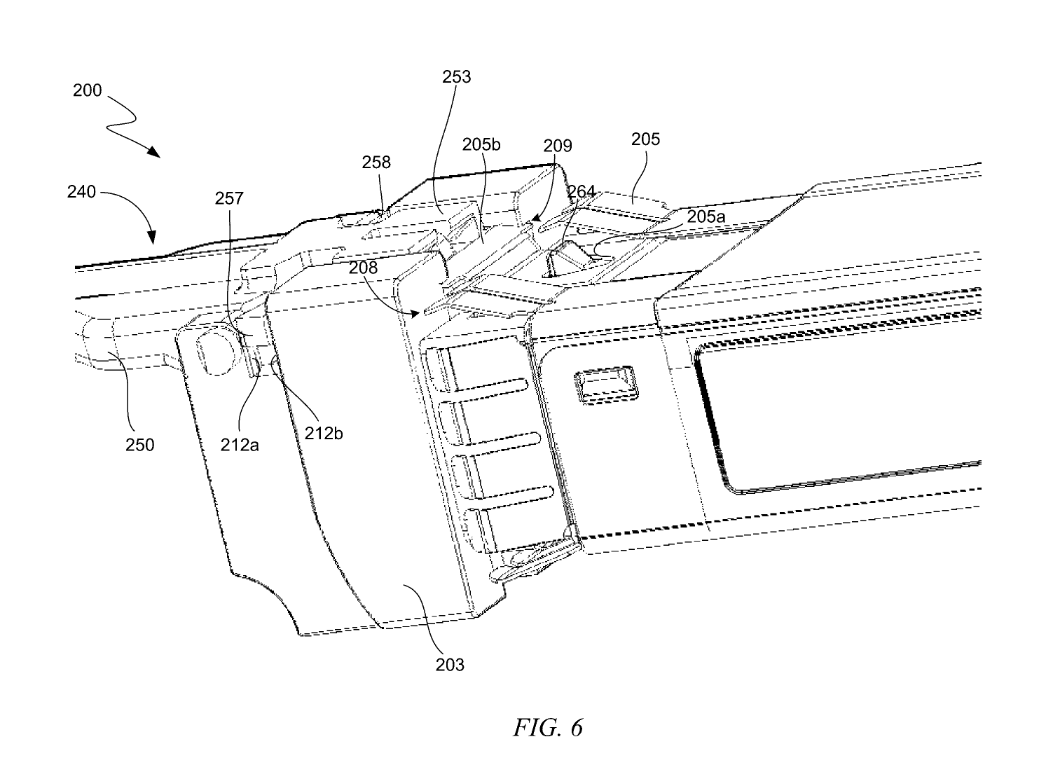

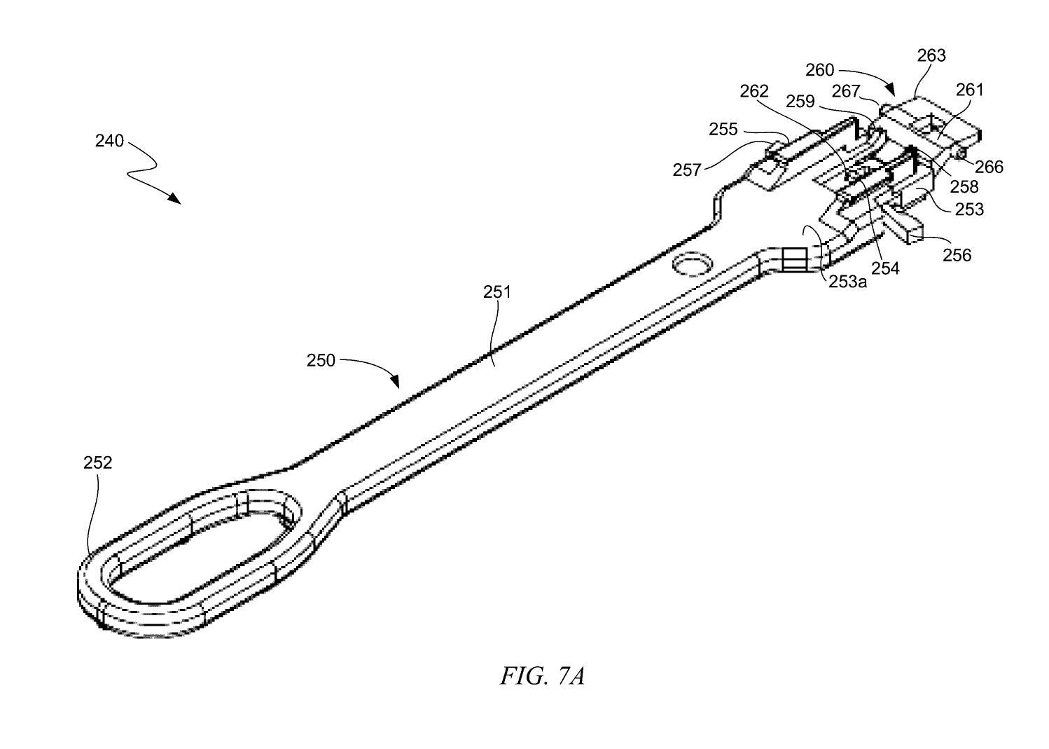

FIG. 4 illustrates a bottom perspective view of an SFP-type optical communications module 200 equipped with the MP latching/delatching system 240 in accordance with an illustrative embodiment. FIG. 5 illustrates an enlarged bottom perspective of the portion of the optical communications module 200 and MP latching/delatching system 240 shown in the dashed circle 241 in FIG. 4. FIG. 6 illustrates an enlarged side perspective of the portion of the optical communications module 200 and MP latching/delatching system 240 shown in the dashed circle 241 in FIG. 4.

The module 200 has an upper housing portion 202 and a lower housing portion 203 that are secured to one another to form the module housing. The lower housing portion 203 is typically made of cast metal and the upper housing portion 202 is typically made of sheet metal, although the invention is not limited with respect to the materials or processes that are used to make the module housing 202, 203. In accordance with this illustrative embodiment, the MP latching/delatching system 240 is secured to the lower housing portion 203. An electromagnetic interference (EMI) collar 205 is secured to the module housing. The EMI collar 205 has spring fingers that have ends that that are in contact with the module housing 202, 203 at regularly spaced intervals.

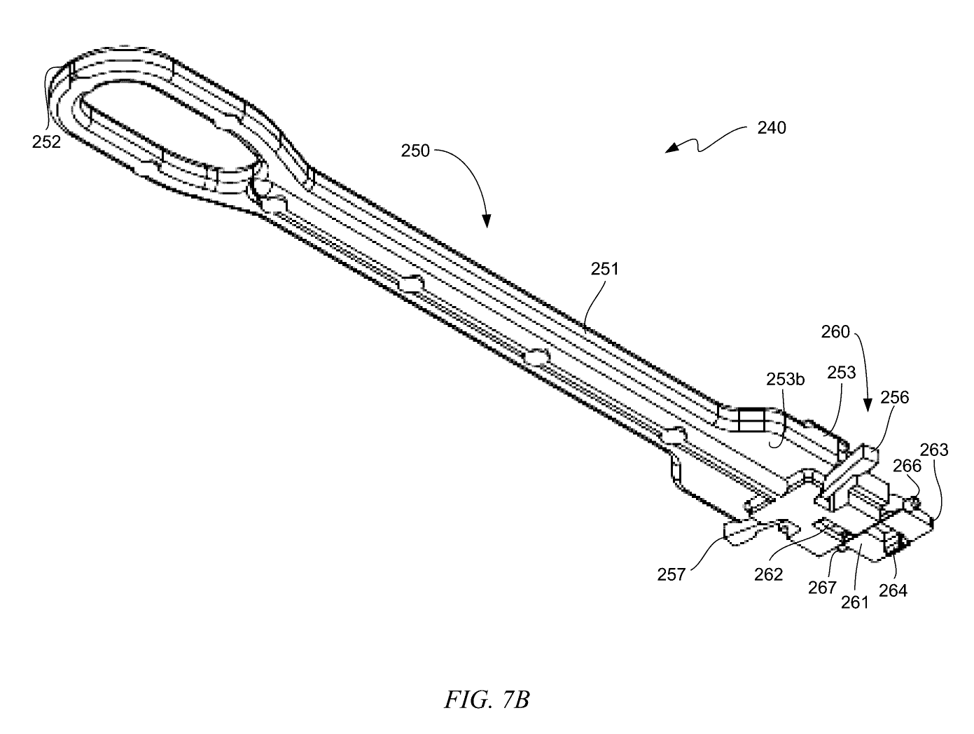

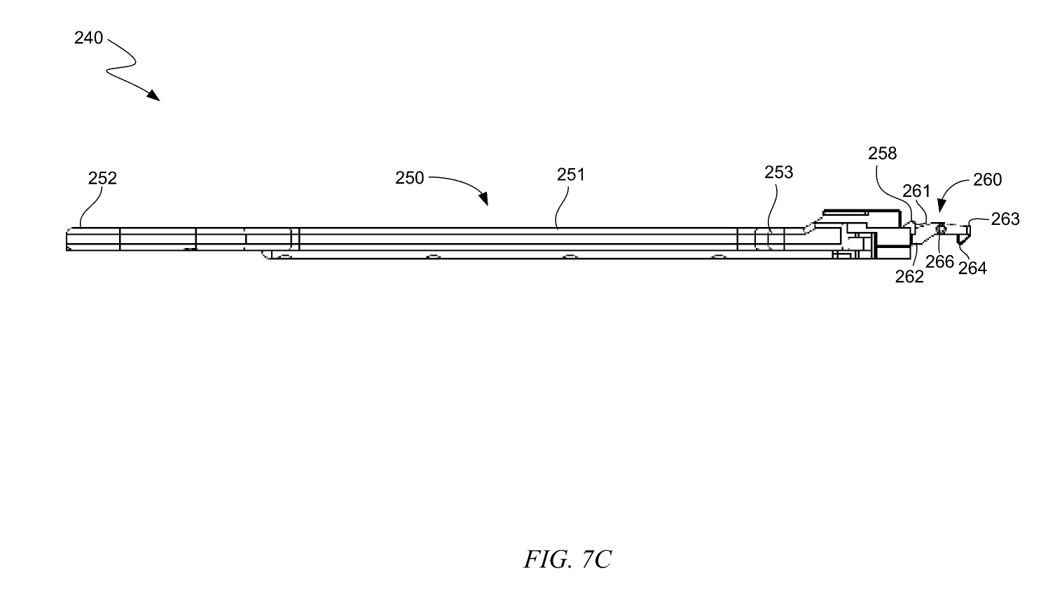

FIGS. 7A and 7B illustrate top and bottom perspective views, respectively, of the MP latching/delatching system 240 shown in FIGS. 4-6. FIG. 7C illustrates a side elevation view of the MP latching/delatching system 240 shown in FIGS. 4-6. FIG. 8 illustrates an enlarged bottom perspective view of the distal end 253 of the pull tab 250 shown in FIGS. 7A-7C with the latch base 260 of the MP latching/delatching system 240 removed. The MP latching/delatching system 240 comprises an elongated pull tab 250 and a latch base 260. The pull tab 250 has a shaft 251, a proximal end 252 and a distal end 253. The latch base 260 has a latch base body 261 that has a proximal end 262, a distal end 263 and a latch locking pin 264. The proximal end 262 of the latch base body 261 is mechanically coupled to the distal end 253 of the pull tab 250 by a mechanical coupling arrangement that is described below in more detail. The distal end 253 of the pull tab 250 has first and second rails 254 and 255 disposed on an upper surface 253a thereof for engaging respective longitudinal slots (not shown) formed in the module housing (not shown), as will be described below in detail. The distal end 253 of the pull tab 250 has first and second spring fingers 256 and 257 disposed thereon for engaging respective lateral slots (not shown) formed in the module housing (not shown), as will be described below in more detail.

The latch base body 261 has first and second pins 266 and 267 formed thereon at opposite ends of a lateral, or transverse, axis of the latch base 260. The lateral axis of the latch base 260 is transverse, or perpendicular, to the longitudinal axis of the pull tab 250. As will be described below in more detail, the latch base 260 is rotationally coupled to the module housing such that the latch base 260 is allowed to rotate a limited amount about the lateral axis that passes through the centers of pins 266 and 267.

First and second push fingers 258 and 259 (FIG. 7A) are disposed on the upper surface 253a of the distal end 253 of the pull tab 250. The first and second push fingers 258 and 259 exert a downward force against the proximal end 262 of the latch base body 261 when the pull tab 250 is pulled away from the cage in the longitudinal direction of the shaft 251 of the pull tab 250. This downward force on the latch base body 261 causes the latch base body 261 to rotate to a limited degree about a fulcrum located on the lateral axis that passes the centers of the pins 266 and 267 of the latch base 260. Rotation of the latch base body 261 about this fulcrum results in the proximal end 262 of the latch base 260 moving in a downward direction and the distal end 263 of the latch base 260 moving in the upward direction. Rotation of the latch base body 261 in this direction by the limited amount places the latch base 260 in an unlatched position and results in the latch locking pin 264 being in a retracted position in which the latch locking pin 264 is no longer engaged with the latch opening (not shown) of the cage (not shown). The module 200 may then be extracted from the cage.

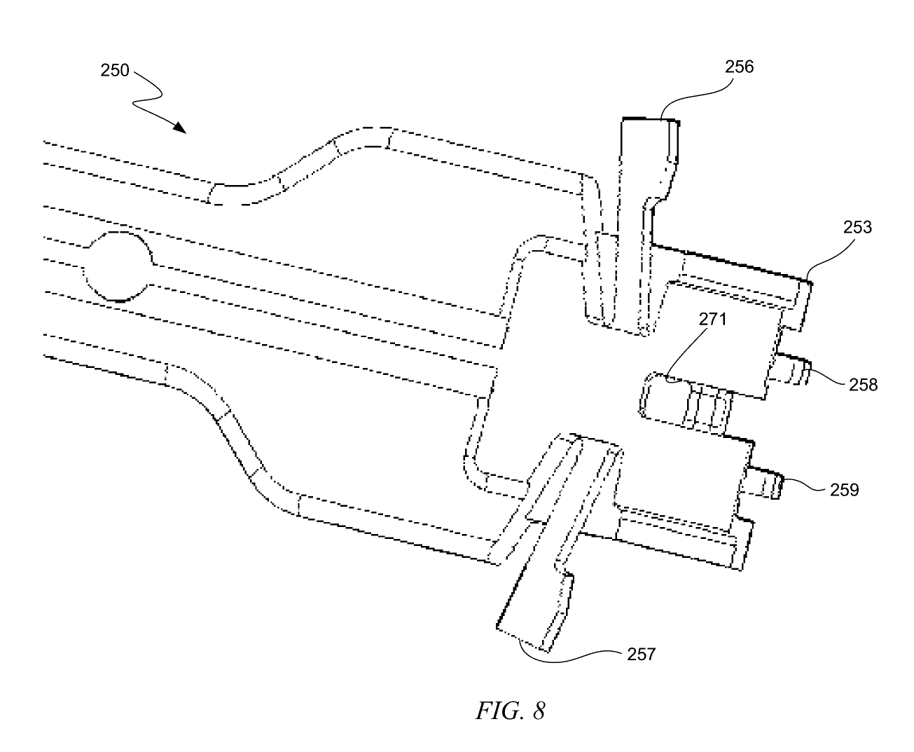

FIG. 9 illustrates a bottom perspective view of the latch base 260 of the MP latching/delatching system 240 shown in FIGS. 7A-7C. The proximal end 262 of the latch base 260 is disposed at the end of a hook-shaped feature 281 that has a first portion 281a that arches downwardly and away from the latch base body 261, a second portion 281b that arches upwardly and away from the latch base body 261, and a third portion 281c that extends in a direction that is generally opposite the direction in which the latch locking pin 264 extends. The upwardly-arching portion of the hook-shaped feature is hooked through an opening 271 (FIG. 8) formed in the distal end 253 of the pull tab 250 to mechanically couple the proximal end 262 of the latch base 260 with the distal end 253 of the pull tab 250.

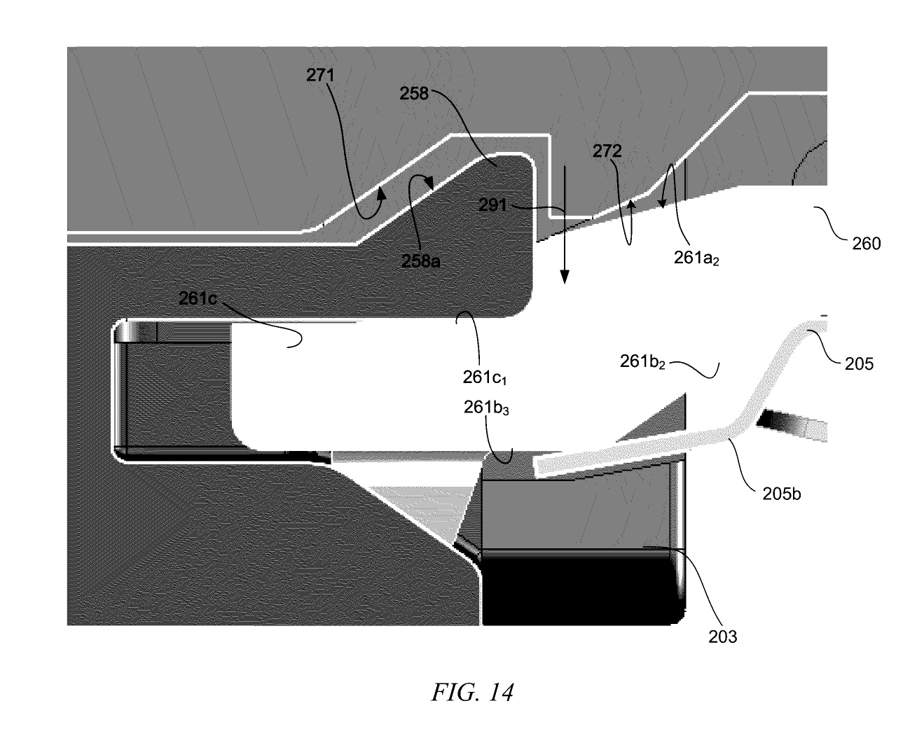

The latch base body 261 has an upper surface 261a and a lower surface 261b. The lower surface 261b has a first generally flat portion 261b₁, a second ramped portion 261b₂ and a third generally flat portion 261b₃. The upper surface 261a has a first generally flat portion 261a₁ and a second ramped portion 261a₂. The latch base body 261 has a lever portion 261c having a generally flat upper surface 261c₁ that makes contact with the first and second push fingers 258 and 259 (FIG. 7A) when a user exerts a pull force on the proximal end 252 of the pull tab 250 in a direction away from the cage and generally parallel to the longitudinal axis of the shaft 251 of the pull tab 250. As will be described below in more detail with reference to FIG. 14, this contact between the push fingers 258 and 259 and the upper surface 261c₁ of the lever portion 261c exerts a downward force on the upper surface 261c₁ that causes the proximal end 262 of the latch base 260 to move in the downward direction and the distal end 263 of the latch base 260 to move in the upward direction as the latch base 260 rotates about its fulcrum.

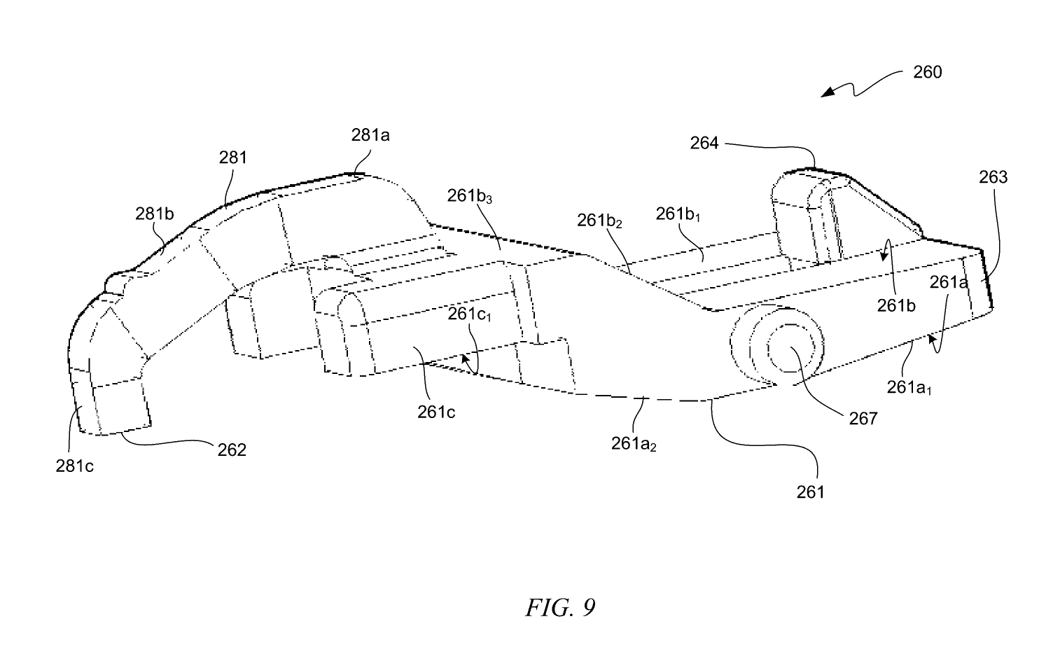

FIG. 10 illustrates a bottom perspective view of a portion of the optical communications module 200 and MP latching/delatching system 240 shown in FIGS. 5 and 6, but with the EMI collar 205 and the pull tab 250 removed. In FIG. 10, it can be seen that the first and second pins 266 and 267 formed on opposite sides of the latch base 260 are aligned along a common transverse axis (perpendicular to the longitudinal axis of the pull tab 250) 268 and sit within respective openings 216 and 217 formed in the lower surface of the lower housing portion 203. This axis is the fulcrum about which the latch base 260 is allowed to rotate by a limited amount when the latch base 260 is moving from the latched position to the delatched position, and vice versa.

With reference again to FIGS. 5 and 6, the first and second spring fingers 256 and 257 disposed on the distal end 253 of the pull tab 250 are disposed in between respective lateral slots defined on one side by surfaces 211a and 211b of the lower housing portion 203 and on the other side by surfaces 212a and 212b of the lower housing portion 203. In FIGS. 5 and 6, the MP latching/delatching system 240 is in the latched position. In the latched position of the MP latching/delatching system 240, the latch locking pin 264 is in the extended position in which the latch locking pin 264 passes through an opening 205a of the EMI collar 205 and through the latch opening (not shown) of the cage (not shown) to latch the module 200 to the cage. When the latch locking pin 264 is in the extended position shown in FIGS. 5 and 6, the spring fingers 256 and 257 are in unloaded states. If a pulling force is exerted on the pull tab 250 in a direction away from the cage generally parallel to the longitudinal axis of the shaft 251 of the pull tab 250, the distal end 253 of the pull tab 250 will begin to move in the same direction, thereby causing the spring fingers 256 and 257 to become loaded such that they begin exerting return forces in the opposite direction of the pull to attempt to urge the distal end 253 of the pull tab 250 back to the position shown in FIGS. 5 and 6. The exertion of these return forces prevents the module 200 from inadvertently sliding out of the cage when an extraction, or pull, force less than that needed for full extraction of the module 200 is exerted on the module 200 and/or on the pull tab 250.

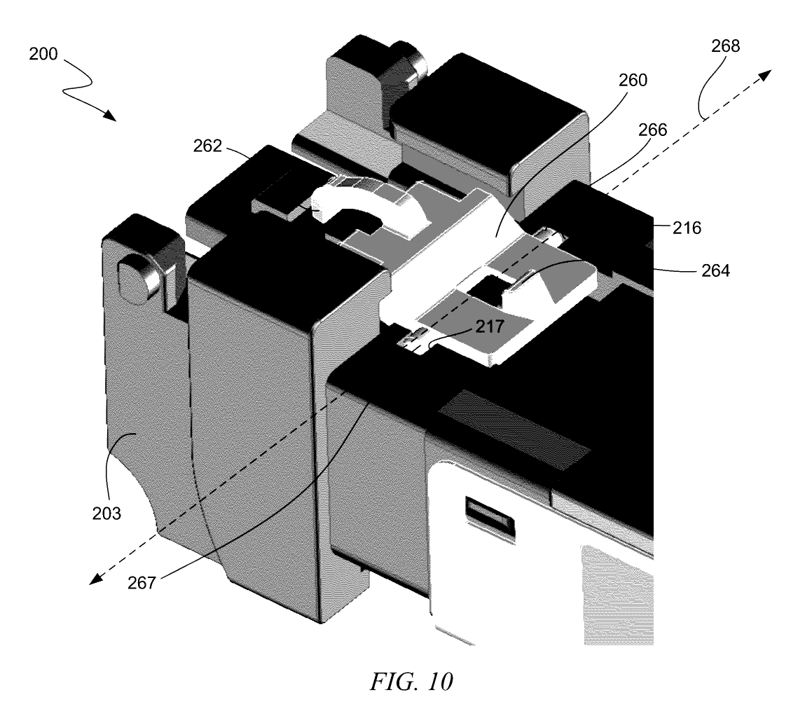

FIG. 11 illustrates a top perspective view of a portion of the optical communications module 200 and the MP latching/delatching system 240. The manner in which the first and second rails 258 and 259 of the pull tab 250 slidingly engage first and second tracks 228 and 229, respectively, of the lower module housing portion 203 can be seen in FIG. 11. The module 200 has first and second receptacles 206 and 207 adapted for mating with first and second optical connectors (not shown), which are LC optical connectors in this illustrative embodiment.

With reference again to FIG. 6, when the EMI collar 205 is secured to the module housing 202, 203, a tongue 205b of the EMI collar 205 is secured inside of slots 208 and 209 of the lower housing portion 203. In this position, the tongue 205b of the EMI collar 205 is in contact with portions of the surfaces 261b₁, 261b₂ and 261b₃ (FIG. 9) of the latch base body 261, and the latch locking pin 264 passes through the opening 205a of the EMI collar 205.

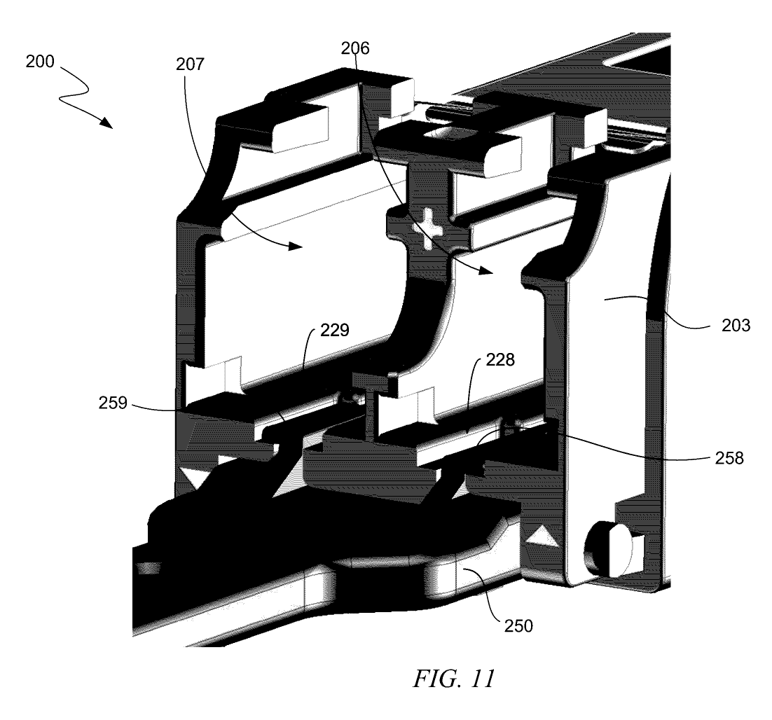

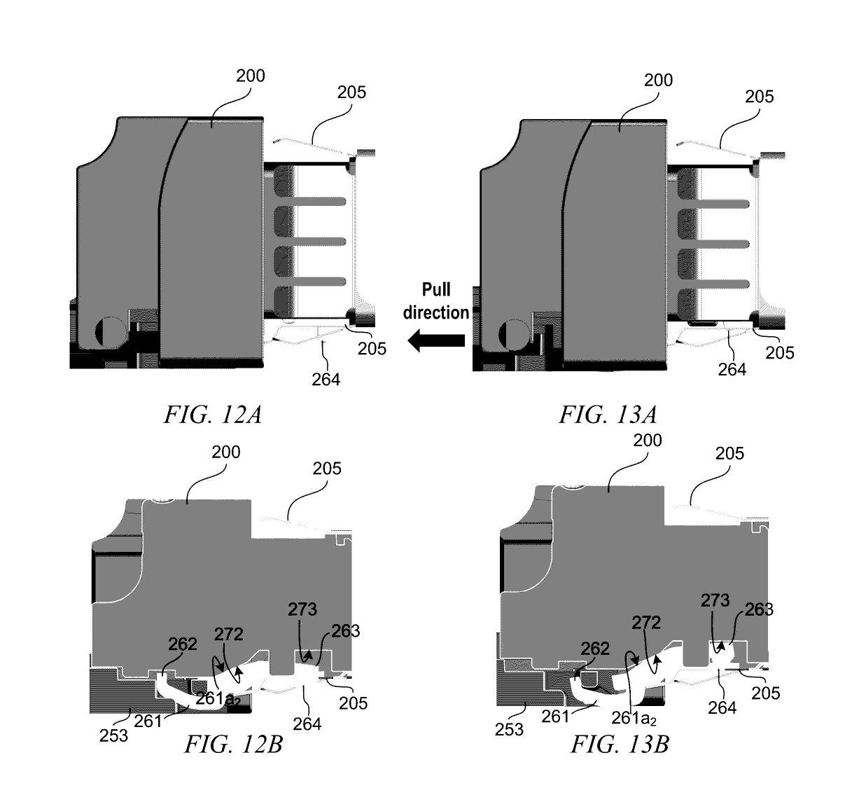

FIGS. 12A and 12B illustrate side plan and cross-sectional views, respectively, of the optical communications module 200 with the latch locking pin 264 in the latched position. FIGS. 13A and 13B illustrate side plan and cross-sectional views, respectively, of the optical communications module 200 with the latch locking pin 264 in the delatched position. FIG. 14 illustrates a side cross-sectional view of a portion of the optical communications module 200 that shows the interaction between the latch locking pin 264, the lower housing portion 203 and one of the push fingers 258 of the MP latching/delatching system 240 as the pull tab 250 is being pulled to move the latch locking pin 264 from the latched position shown in FIGS. 12A and 12B to the delatched position shown in FIGS. 13A and 13B.

The manner in which the pull tab 250 may be used to delatch the module 200 from a cage will now be described. When an extraction force is exerted on the proximal end 252 of the pull tab 250 (FIG. 4) in a direction away from the cage generally parallel to the longitudinal axis of the shaft 251 of the pull tab 250, the ramped surface 258a (FIG. 14) of the push finger 258 (FIG. 7A) engages the ramped surface 271 (FIG. 14) of the lower housing portion 203. The ramped surfaces 258a and 271 are shown in FIG. 14 as being separated from one another in order to clearly delineate the surfaces 271 and 258a, but these surfaces will be in contact with one another once the user begins applying the extraction force to the pull tab 250. This engagement between the ramped surfaces 258a and 271 causes the push finger 258 to be deflected downwardly in the direction indicated by arrow 291 in FIG. 14. In this way, the pulling of the pull tab 250 in the axial direction of the shaft 251 is converted into a downwardly-directed motion of the push finger 258.

The downwardly-directed push finger 258 exerts a force in the direction of arrow 291 against the surface 261c₁ of the lever portion 261c (FIG. 9) of the latch base 260. This downward force on the latch base body 261 causes the latch base body 261 to rotate to a limited degree about its fulcrum in between inner surface 272 of the lower housing portion 203 and the tongue 205b of the EMI collar 205. The extent of rotation is limited by inner surfaces 272 (FIGS. 12B, 13B and 14) and 273 (FIGS. 12B and 13B) of the lower housing portion 203. During this rotation, the proximal end 262 (FIGS. 12B and 13B) of the latch base 260 moves in a downward direction and the distal end 263 of the latch base 260 moves in an upward direction. When the distal end 263 of the latch base 260 moves in the upward direction (FIG. 13B), the latch locking pin 264 retracts from the latch opening (not shown) of the cage (not shown). The module 200 may then be extracted from the cage.

As indicated above, with the MP latching/delatching system 240, it is not necessary to unplug the optical connectors from the receptacles 206 and 207 prior to delatching and extracting the module 200 from the cage. As indicated above, eliminating the requirement of disconnecting the optical connectors before extracting the module 200 from the cage saves a significant amount of time and reduces the likelihood that the ends of the optical fibers held in the optical connectors and the module will become dirty or contaminated.

The module 200 equipped with the MP latching/delatching system 240 is latched to the cage by using the pull tab 205 to push the module 200 into the cage. As the module 200 is pushed into the cage, the latch locking pin 264 is rotated about its fulcrum in a direction that is opposite the delatching direction to place the pin 264 in the extended position shown in FIGS. 12A and 12B so that the pin 264 engages the latch opening of the cage. As indicated above, the engagement between the spring fingers 256 and 257 and the slots defined by the surfaces 211a/211b and 212a/212b (FIG. 5) of the lower housing portion 203 provides a return force that urges the module 200 towards the cage to reduce the likelihood that the module 200 will be accidentally delatched from the cage.

It should be noted that the invention has been described with reference to illustrative embodiments for the purpose of demonstrating principles and concepts of the invention. The invention is not limited to these embodiments, as will be understood by persons of skill in the art in view of the description provided herein. For example, although the MP latching/delatching system 240 has been described as having a particular configuration of elements that perform particular functions or have particular purposes, many variations may be made to the MP latching/delatching system 240, as will be understood by persons of skill in the art in view of the description provided herein.

What is claimed is:

1. An optical communications module adapted to be mated with a cage, the module comprising:
a module housing that houses components of the optical communications module;
an elongated pull tab having a proximal end, a distal end and a shaft interconnecting the proximal and distal ends, the shaft having a longitudinal axis; and
a latch base mechanically coupled with the distal end of the pull tab and movably engaged with the module housing, the latch base including a latch locking pin adapted to engage an opening of the cage when the module is mated with the cage, wherein movement of the pull tab from a latched position to a delatched position causes the pin to move from an extended position to a retracted position in which the pin is disengaged from the opening of the cage to allow the module to be extracted from the cage.

2. The optical communications module of claim 1, wherein the module housing has an electromagnetic interference (EMI) collar fixedly secured thereto, the EMI collar having an opening formed therein through which the pin extends to engage the opening of the cage when the latch locking pin is in the extended position.

3. The optical communications module of claim 1, wherein a proximal end of the latch base is mechanically coupled with the distal end of the pull tab, the latch locking pin being disposed on a distal end of the latch base, and wherein movement of the pull tab to the delatched position causes the proximal end of the latch base to move in a downward direction and causes the distal end of the latch base to move in an upward direction away from the opening of the cage.

4. The optical communications module of claim 3, wherein a portion of the latch base in between the proximal and distal ends of the latch base is rotationally coupled to the module housing to allow the latch base to have limited rotational movement about a transverse axis that is perpendicular to the longitudinal axis of the shaft of the pull tab.

5. The optical communications module of claim 4, wherein the distal end of the pull tab has at least a first push finger disposed thereon, the first push finger having a first ramped surface that comes into sliding contact with at least a first ramped interior surface of the module housing as the pull tab is being moved from the latched position to the delatched position, and wherein the sliding contact between the first ramped surface of the first push finger the first ramped interior surface of the module housing results in a downwardly-directed motion of the first push finger against the proximal end of the latch base to cause the proximal end of the latch base to move in the downward direction and the distal end of the latch base to move in the upward direction away from the opening of the cage.

6. The optical communications module of claim 4, wherein the portion of the latch base in between the proximal and distal ends of the latch base that is rotationally coupled to the module housing are first and second pins disposed on opposite sides of the latch base, the first and second pins having centers that are coaxial with the transverse axis, the first and second pins being seated in first and second slots formed in the module housing.

7. The optical communications module of claim 4, wherein the distal end of the pull tab has at least a first rail thereon that slidingly engages a first track formed in the module housing, and wherein the first rail and first track are parallel to the longitudinal axis of the shaft.

8. The optical communications module of claim 4, wherein the mechanical coupling between the proximal end of the latch base and the distal end of the pull tab comprises a hook-shaped feature on the proximal end of the latch base and an opening formed in the distal end of the pull tab, wherein the hook-shaped feature is hooked through the opening formed in the distal end of the pull tab.

9. The optical communications module of claim 4, further comprising:
at least a first spring arm disposed on the distal end of the pull tab, a distal end of the first spring arm being in contact with one or more surfaces of the module housing, wherein movement of the pull tab from the latched position toward the delatched position causes the first spring arm to become loaded, and wherein the loaded spring arm places a return force on the pull tab in a direction toward the cage.

10. A moving pin (MP) latching/delatching system for use with a module housing of an optical communications module adapted to be mated with a cage, the MP latching/delatching system comprising:
an elongated pull tab having a proximal end, a distal end and a shaft interconnecting the proximal and distal ends, the shaft having a longitudinal axis; and
a latch base mechanically coupled with the distal end of the pull tab and movably engaged with the module housing, the latch base including a latch locking pin adapted to engage an opening of the cage when the module is mated with the cage, wherein movement of the pull tab from a latched position to a delatched position causes the pin to move from an extended position to a retracted position in which the pin is disengaged from the opening of the cage to allow the module to be extracted from the cage.

11. The MP latching/delatching system of claim 10, wherein a proximal end of the latch base is mechanically coupled with the distal end of the pull tab, the latch locking pin being disposed on a distal end of the latch base, and wherein movement of the pull tab to the delatched position causes the proximal end of the latch base to move in a downward direction and causes the distal end of the latch base to move in an upward direction away from the opening of the cage.

12. The MP latching/delatching system of claim 11, wherein a portion of the latch base in between the proximal and distal ends of the latch base is rotationally coupled to the module housing to allow the latch base to have limited rotational movement about a transverse axis that is perpendicular to the longitudinal axis of the shaft of the pull tab.

13. The MP latching/delatching system of claim 12, wherein the distal end of the pull tab has at least a first push finger disposed thereon, the first push finger having a first ramped surface that comes into sliding contact with at least a first ramped interior surface of the module housing as the pull tab is being moved from the latched position to the delatched position, and wherein the sliding contact between the first ramped surface of the first push finger the first ramped interior surface of the module housing results in a downwardly-directed motion of the first push finger against the proximal end of the latch base to cause the proximal end of the latch base to move in the downward direction and the distal end of the latch base to move in the upward direction away from the opening of the cage.

14. The MP latching/delatching system of claim 12, wherein the portion of the latch base in between the proximal and distal ends of the latch base that is rotationally coupled to the module housing are first and second pins disposed on opposite sides of the latch base, the first and second pins having centers that are coaxial with the transverse axis, the first and second pins being seated in first and second slots formed in the module housing.

15. The MP latching/delatching system of claim 12, wherein the distal end of the pull tab has at least a first rail thereon that slidingly engages a first track formed in the module housing, and wherein the first rail and first track are parallel to the longitudinal axis of the shaft.

16. The MP latching/delatching system of claim 12, wherein the mechanical coupling between the proximal end of the latch base and the distal end of the pull tab comprises a hook-shaped feature on the proximal end of the latch base and an opening formed in the distal end of the pull tab, wherein the hook-shaped feature is hooked through the opening formed in the distal end of the pull tab.

17. The MP latching/delatching system of claim 12, further comprising:
at least a first spring arm disposed on the distal end of the pull tab, a distal end of the first spring arm being in contact with one or more surfaces of the module housing, wherein movement of the pull tab from the latched position toward the delatched position causes the first spring arm to become loaded, and wherein the loaded spring arm places a return force on the pull tab in a direction toward the cage.

18. A method for delatching an optical communications module from a cage to allow the optical communications module to be extracted from the cage, the method comprising:
with a moving pin (MP) latching/delatching system mechanically coupled with a module housing of the optical communications module, pulling a pull tab of the MP latching/delatching system in a direction away from the cage generally parallel to a longitudinal axis of the pull tab from a latched position to a delatched position, wherein pulling the pull tab to the delatched position causes a latch base that is mechanically coupled with a distal end of the pull tab and movably engaged with the module housing to move from a latched position to a delatched position, the latch base including a latch locking pin adapted to engage an opening of the cage when the module is mated with the cage, wherein movement of the latch base from the latched position to the delatched position causes the pin to move from an extended position to a retracted position in which the pin is disengaged from the opening of the cage to allow the module to be extracted from the cage.

19. The method of claim 18, wherein a proximal end of the latch base is mechanically coupled with the distal end of the pull tab, the latch locking pin being disposed on a distal end of the latch base, and wherein movement of the pull tab to the delatched position causes the proximal end of the latch base to move in a downward direction and causes the distal end of the latch base to move in an upward direction away from the opening of the cage.

20. The method of claim 19, wherein a portion of the latch base in between the proximal and distal ends of the latch base is rotationally coupled to the module housing to allow the latch base to have limited rotational movement about a transverse axis that is perpendicular to the longitudinal axis of the shaft of the pull tab.

21. The method of claim 20, wherein the distal end of the pull tab has at least a first push finger disposed thereon, the first push finger having a first ramped surface that comes into sliding contact with at least a first ramped interior surface of the module housing as the pull tab is being moved from the latched position to the delatched position, and wherein the sliding contact between the first ramped surface of the first push finger the first ramped interior surface of the module housing results in a downwardly-directed motion of the first push finger against the proximal end of the latch base to cause the proximal end of the latch base to move in the downward direction and the distal end of the latch base to move in the upward direction away from the opening of the cage.

22. The method of claim 20, wherein the portion of the latch base in between the proximal and distal ends of the latch base that is rotationally coupled to the module housing are first and second pins disposed on opposite sides of the latch base, the first and second pins having centers that are coaxial with the transverse axis, the first and second pins being seated in first and second slots formed in the module housing.

23. The method of claim 20, wherein the distal end of the pull tab has at least a first rail thereon that slidingly engages a first track formed in the module housing, and wherein the first rail and first track are parallel to the longitudinal axis of the shaft.

24. The method of claim 20, wherein the mechanical coupling between the proximal end of the latch base and the distal end of the pull tab comprises a hook-shaped feature on the proximal end of the latch base and an opening formed in the distal end of the pull tab, wherein the hook-shaped feature is hooked through the opening formed in the distal end of the pull tab.

25. The method of claim 20, further comprising:
at least a first spring arm disposed on the distal end of the pull tab, a distal end of the first spring arm being in contact with one or more surfaces of the module housing, wherein movement of the pull tab from the latched position toward the delatched position causes the first spring arm to become loaded, and wherein the loaded spring arm places a return force on the pull tab in a direction toward the cage.
